(19) United States
(12) Patent Application Publication
(10) Pub. No.: US 2021/0348688 A1
(43) Pub. Date: Nov. 11, 2021

(54) STOP VALVE

(71) Applicants: CHIN-YU WU, CHANGHUA COUNTY (TW); CHENG YU FAUCET HARDWARE CO., LTD., CHANGHUA COUNTY (TW); YUYANG HARDWARE CO., LTD., CHANGHUA COUNTY (TW)

(72) Inventor: CHIN-YU WU, CHANGHUA COUNTY (TW)

(21) Appl. No.: 16/866,833

(22) Filed: May 5, 2020

(51) Int. Cl. F16K 1/52; F16K 1/36; F16K 1/46

(52) U.S. Cl. CPC F16K 1/523; F16K 1/46; F16K 1/36

(57) ABSTRACT

A stop valve includes a valve member having an inlet and an outlet, a chamber defined in the valve member, and a passage defined through the top of the valve member. The passage communicates with the chamber. A shaft is inserted into the valve member and includes a cylindrical portion located in the chamber. A head extends from the cylindrical portion and protrudes beyond the passage of the valve member. The cylindrical portion has a first bore communicating with the inlet, and a second bore communicating with the outlet. A stepped portion is formed to the opening of the second bore. A block is engaged with the stepped portion and has a hole which communicates with the second bore and the outlet. A knob is connected to the head of the shaft. The block is easily manufactured and does not disengaged from the inlet.

### BACKGROUND OF THE INVENTION

### 1. Fields of the Invention

The present invention relates to a stop valve, and more particularly, to a stop valve that is easily manufactured with low manufacturing cost.

### 2. Descriptions of Related Art

The conventional stop valve is used to a plumbing system and allows the users to control the fluid to be obtained from a selected outlet. Generally, a water filtering system is cooperated with the stop valve so that the filtered water or the tap water can be selectively obtained by operating the stop valve. A conventional stop valve known to applicant comprises a valve body with a chamber defined therein. An inlet and a first outlet are respectively defined through the wall of the top and bottom of the valve body, and an entrance and a second outlet are defined through a peripheral wall of the valve body. A connector is connected to each of the inlet and the first outlet. The second outlet includes a gradually expanded portion which has inner threads to which a faucet is connected. A shaft extends into the chamber and includes a first path that communicates with the inlet and the first outlet. A second path is formed along the outside of the valve body and communicates with the first path. The second path expands 90 degrees along the valve body. A stop plate is located in the second path. The shaft includes a connection section which extends beyond the entrance of the valve body. A head is formed to the distal end of the connection section. A knob is mounted to the head and connected to the head.

The stop plate is located in a rectangular recess defined in the shaft. However, it is noted that the valve body is a small part so that it is difficult to make a rectangular recess in the shaft, the rectangular recess has to be machined in different steps, and this increases problems about quality-control issues.

The present invention intends to provide a stop valve to eliminate the shortcomings mentioned above.

### SUMMARY OF THE INVENTION

The present invention relates to a stop valve and comprises a valve member having an inlet and an outlet, and a chamber is defined in the valve member. A passage is defined through the top of the valve member and communicates with the chamber. A shaft is inserted into the valve member and includes a cylindrical portion which is located in the chamber, and a head extends from the top of the cylindrical portion and protrudes beyond the passage of the valve member. The cylindrical portion has a first bore and a second bore, wherein the first bore communicates with the inlet, and the second bore communicates with the outlet. A stepped portion is formed along the opening of the second bore. A block is engaged with the stepped portion and has a hole. The hole communicates with the second bore and the outlet. The inner diameter of the hole is smaller than the inner diameter of the outlet. A knob includes a skirt and a lever which extends radially from the skirt. The skirt is mounted and fixed to the head of the shaft so as to control the shaft to rotate.

The advantages of the present invention are that the shaft is located corresponding to the inlet, and a block is engaged with the stepped portion of the opening of the second bore. The stepped portion is a circular area which can be made by one step of machining. The block can also be easily made to be engaged with the stepped portion. When compared with the rectangular recess found in the conventional stop valve, the stop valve of the present invention is easier to be manufactured.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the stop valve of the present invention;

FIG. 2 is an exploded view of the stop valve of the present invention;

FIG. 3 is a cross sectional view of the stop valve of the present invention;

FIG. 4 is a cross sectional view to show that the shaft is rotated an angle by rotating the knob;

FIG. 5 shows that two connectors are connected to the stop valve of the present invention, and

FIG. 6 shows another embodiment of the stop valve of the present invention, and two connectors are connected to the stop valve in FIG. 6.

### DETAILED DESCRIPTION OF THE PREFERRED EMBODIMENT

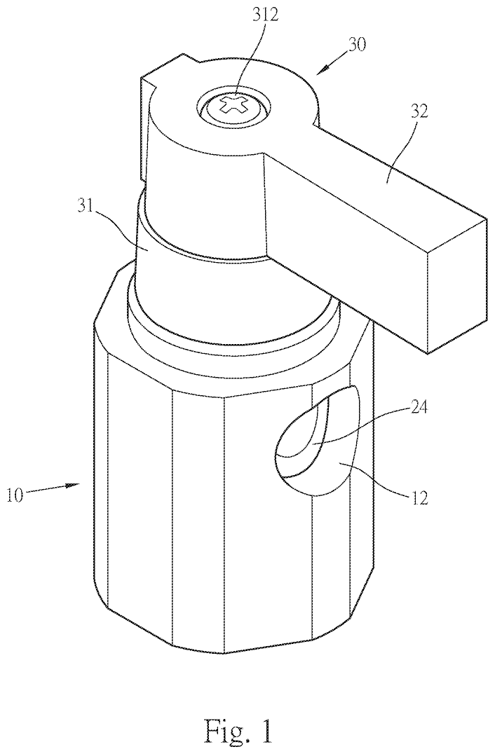

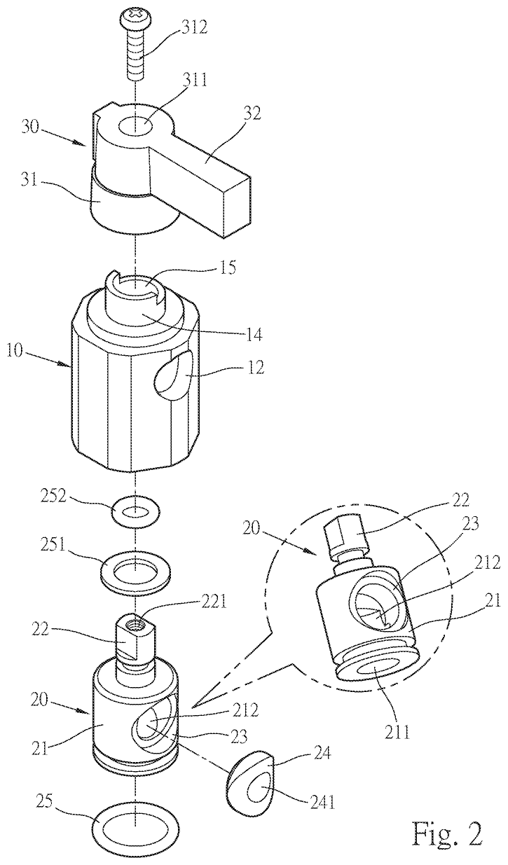

Referring to FIGS. 1 to 3, the stop valve of the present invention comprises a valve member 10, a shaft 20 and a knob 30. The valve member 10 includes an inlet 11 and an outlet 12, and a chamber 13 is defined in the valve member 10. A passage 15 is defined through the top of the valve member 10 and communicates with the chamber 13. A tubular portion 14 extends from the top of the valve member 10, and the passage 15 is located at the center of the tubular portion 14. The outlet 12 is located in the peripheral wall of the valve member 10, and the inlet 11 is located in one of two ends of the valve member 10, so that the inlet 11 and the outlet 12 are formed an inverted L-shaped arrangement.

The shaft 20 is inserted into the valve member 10 and includes a cylindrical portion 21 which is located in the chamber 13. A head 22 extends from the top of the cylindrical portion 21 and protrudes beyond the passage 15 of the valve member 10. The head 22 includes a non-circular cross section, in this embodiment, the head 22 is a rectangular part. A threaded hole 221 is defined in the head 22. The cylindrical portion 21 includes a first bore 211 and a second bore 212, wherein the first bore 211 communicates with the inlet 11, and the second bore 212 communicates with the outlet 12. The axis of the first bore 211 is perpendicular to the axis of the second bore 211. A stepped portion 23 is formed along the opening of the second bore 212 and is a circular shape. The block 24 is a round block which is shaped to be engaged with the stepped portion 23 and has a hole 241 defined through the center of the block 24. The hole 241 communicates with the second bore 212 and the outlet 12. The inner diameter of the hole 241 is smaller than the inner diameter of the outlet 12. A first sealing ring 25 is connected to the underside of the cylindrical portion 21. A washer 251 is mounted to the head 22 and rested on the top of the cylindrical portion 21, and a second sealing ring 252 is mounted to the head 22. The first and second sealing rings 25, 252 ensure the stop valve from leakage.

The knob 30 includes a skirt 31 and a lever 32 which extends radially from the skirt 31. The skirt 31 is mounted and fixed to the head 22 of the shaft 20. A reception area 33 is axially defined in the underside of the skirt 31 so as to be engaged with the head 22. The skirt 31 further includes a sink hole 311 defined in the top thereof. The knob 30 has a restriction portion 34 which is located corresponding to the tubular portion 14 so that when the knob 30 is rotated, the restriction portion 34 is stopped by the tubular portion 14 so as to restrict the knob 30 to be rotated with a 90-degree range.

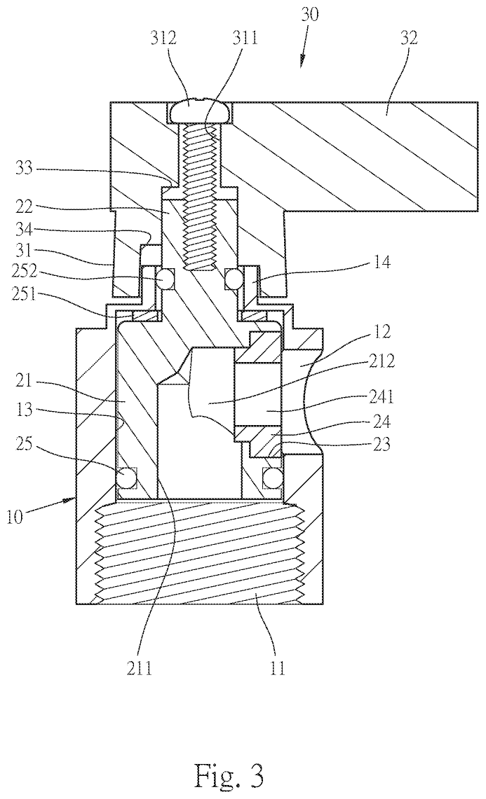

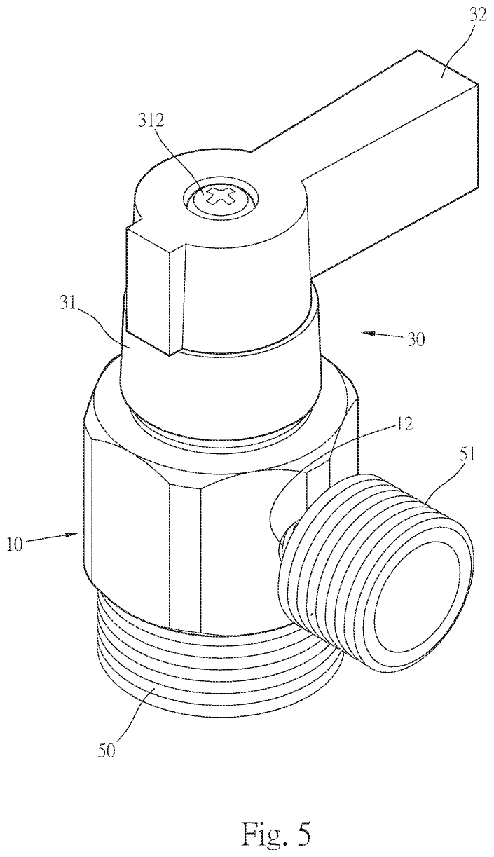

When in assembling, the shaft 20 together with the block 24 are inserted into the valve member 10 via the inlet 11 to let the head 22 protrudes beyond the passage 15. The knob 30 is mounted to the head 22, and the restriction portion 34 contacts the tubular portion 14, and the head 22 is engaged with the reception area 33. Therefore, the knob 30 is able to rotate the shaft 20. A bolt 312 extends through the knob 30 and is threadedly connected to the threaded hole 221 to fix the knob 30 to the head 22. The outer diameter of the block 24 is larger than the inner diameter of the outlet 12, and the block 24 is shaped to be engaged with the stepped portion 23, so that the block 24 is clamped as shown in FIG. 3 and does disengaged from the outlet 12. As shown in FIG. 5, two connectors 50, 51 are respectively connected to the inlet 11 and the outlet 12 so as to be connected with hoses or pipes.

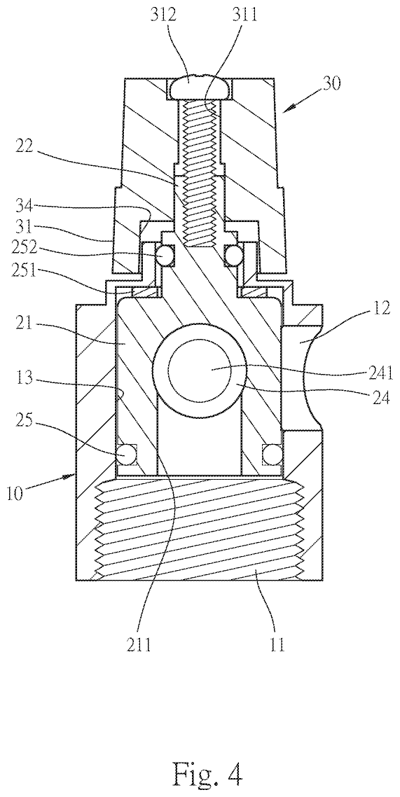

As shown in FIGS. 3 and 4, the use rotates the knob 30 by operating the lever 32 to align the second bore 212 with the outlet 12, and the hole 241 of the block 24 communicates with the outlet 12, so that the water from the inlet 11 flows out from the outlet 12 via the second bore 212 and the hole 241.

On the contrary, when the shaft 20 is rotated 90 degrees, the hole 241 of the block 24 is not in alignment with the outlet 12 so that the outlet 12 is blocked by the shaft 20. The second bore 212 does not communicate with the outlet 12 so that the valve member 10 is in shut-off status.

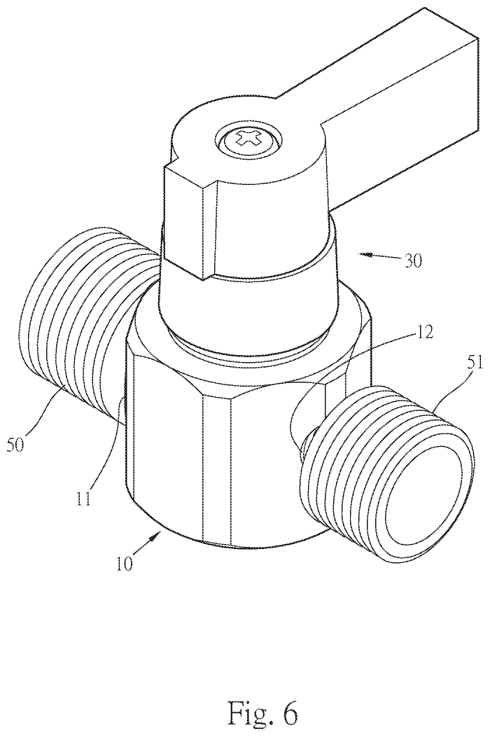

As shown in FIGS. 1 and 6, another embodiment of the stop valve of the present invention, wherein the inlet 11 and the outlet 12 are located in the peripheral wall of the valve member 10, and are located diametrically opposite to each other. Two connectors 50, 51 are connected to the inlet 11 and the outlet 12.

While we have shown and described the embodiment in accordance with the present invention, it should be clear to those skilled in the art that further embodiments may be made without departing from the scope of the present invention.

What is claimed is:

1. A stop valve comprising:
a valve member having an inlet and an outlet, a chamber defined in the valve member, a passage defined through a top of the valve member and communicating with the chamber;
a shaft inserted into the valve member and having a cylindrical portion which is located in the chamber, a head extending from a top of the cylindrical portion and protruding beyond the passage of the valve member, the cylindrical portion having a first bore and a second bore, the first bore communicating with the inlet, the second bore communicating with the outlet, a stepped portion formed along an opening of the second bore, the block engaged with the stepped portion and having a hole defined through a center thereof, the hole communicating with the second bore and the outlet, an inner diameter of the hole being smaller than an inner diameter of the outlet, and
a knob including a skirt and a lever which extends radially from the skirt, the skirt mounted and fixed to the head of the shaft.

2. The stop valve as claimed in claim 1, wherein the valve member includes a tubular portion extending from the top thereof, the passage is located at a center of the tubular portion, the knob has a restriction portion which is located corresponding to the tubular portion so as to restrict the knob to be rotated with a 90-degree range.

3. The stop valve as claimed in claim 1, wherein the outlet is located in a peripheral wall of the valve member, the inlet is located in an end of the valve member, the inlet and the outlet are formed an inverted L-shaped arrangement.

4. The stop valve as claimed in claim 1, wherein a first sealing ring is connected to an underside of the cylindrical portion, a washer is mounted to the head and rested on the top of the cylindrical portion, a second sealing ring is mounted to the head.

5. The stop valve as claimed in claim 1, wherein a reception area is axially defined in an underside of the skirt so as to be engaged with the head, the knob includes a sink hole formed in a top thereof, a bolt extends through the knob and secures the knob to the head.

6. The stop valve as claimed in claim 1, wherein the inlet and the outlet are located in a peripheral wall of the valve member, and are located diametrically opposite to each other.
